(19) United States
(12) Patent Application Publication
(10) Pub. No.: US 2019/0137932 A1
(43) Pub. Date: May 9, 2019

(54) WIDE-FIELD IMAGING OF BIREFRINGENT CRYSTALS AND OTHER MATERIALS USING LENS-FREE POLARIZED MICROSCOPE

(71) Applicant: THE REGENTS OF THE UNIVERSITY OF CALIFORNIA, Oakland, CA (US)

(72) Inventors: Aydogan Ozcan, Los Angeles, CA (US); Yibo Zhang, Los Angeles, CA (US); Seung Yoon Lee, Los Angeles, CA (US); John D. Fitzgerald, Los Angeles, CA (US)

(73) Assignee: THE REGENTS OF THE UNIVERSITY OF CALIFORNIA, Oakland, CA (US)

(21) Appl. No.: 16/302,087

(22) PCT Filed: May 24, 2017
(86) PCT No.: PCT/US2017/034311

§ 371 Date: Nov. 15, 2018

Related U.S. Application Data
(60) Provisional application No. 62/341,540, filed on May 25, 2016.

(51) Int. Cl. G03H 1/04; G03H 1/00; G03H 1/08; H04N 5/232; G06T 5/50

(52) U.S. Cl. CPC G03H 1/0465; G06T 3/4053; G03H 1/0443; G03H 1/0866; H04N 5/23232; G06T 5/50; G03H 2001/005; G03H 2001/0471; G03H 2001/0447; G03H 2222/31; G03H 2223/22; G03H 2226/02; G03H 2226/11; G06T 2207/20224; G06T 2207/30004; G06T 2207/10056; G03H 1/0005

(57) ABSTRACT

A method of imaging a sample having birefringent crystals (or other materials) using a lens-free polarized microscopy device includes illuminating the sample contained on a sample holder with circularly polarized partially coherent or coherent light and capturing lower resolution holographic images of the birefringent crystals with an image sensor. A polarization analyzer unit made from a λ/4 retarder and a linear polarizer is positioned between the sample holder and the image sensor. The lower resolution holographic images are obtained with the polarization analyzer unit in two different orientations (e.g. ˜90° orientations). Phase-retrieved, higher resolution images of the birefringent crystals at the different orientations are obtained using the lower resolution holographic images. A differential image is generated from the respective phase-retrieved, higher resolution images. An object support mask is applied to identify the birefringent crystals which can then be pseudo-colored.

### RELATED APPLICATION

This Application claims priority to U.S. Provisional Patent Application No. 62/341,540 filed on May 25, 2016, which is hereby incorporated by reference in its entirety. Priority is claimed pursuant to 35 U.S.C. § 119 and any other applicable statute.

### TECHNICAL FIELD

The technical field generally relates to methods and devices for detecting birefringent crystals or birefringent materials in a sample. In one embodiment, the technical field relates to methods and devices for observing monosodium urate (MSU) crystals and calcium pyrophosphate (CPP) dihydrate crystals in synovial fluid aspirated from a subject's joint for the diagnosis of gout and pseudogout, respectively.

### BACKGROUND

Gout is a type of inflammatory arthritis caused by the deposition of monosodium urate (MSU) crystals in the joints and periarticular structures such as the tendons and ligaments. During an acute gout attack, the patient experiences severe pain and swelling of the affected structures which can often be debilitating for the patient. The prevalence of gout has been gradually increasing by as much as fourfold for the past five decades, and is the most common type of inflammatory arthritis in the United States affecting over 8 million adults, 3.9% of the entire population. Gout is caused by a combination of factors including diet, medication, and genetics and it occurs more commonly in individuals who consume red meat, consume beer, and are overweight.

Pseudogout is clinically similar to gout but caused by the deposition of calcium pyrophosphate (CPP) crystals in and around joints including cartilage, menisci and synovial fluid. Diagnosis of pseudogout can be made by identification of CPP crystals from synovial fluid or other body tissue. CPP crystals are weakly and positively birefringent. Estimates of CPP disease (CPPD) are harder to specify given the greater difficulty identifying CPP crystals (in comparison to MSU crystals), but best estimates put the prevalence of CPPD at 10 million adult Americans.

The pathogenesis of gout is complex, involving abnormalities in both metabolism and immunity. The key components include hyperuricemia (high level of serum urate) and MSU crystallization. Uric acid is a byproduct of purine metabolism, degraded by the enzyme uricase by most mammals; however, humans lack this enzyme because of multiple evolutional mutations of its coding gene and hence have higher levels of serum urate than other mammals. Once serum urate rises above 6.8 mg/dL, urate can form MSU crystals under certain environmental factors, (typically in and around joints) which then act as a potent trigger of inflammation in the joints. As such, diseases that are caused by crystal deposition of the joints are defined as crystal arthropathy. The etiology of CPPD is less clear. Crystals typically form within cartilage or menisci and may take decades to form. Crystal formation is most commonly associated with concurrent osteoarthritis, but may also be prevalent in conditions affecting calcium metabolism.

Diagnosis of a rheumatic disorder such as crystal arthropathy can be established by identifying these birefringent crystals, namely MSU crystals for gout and calcium pyrophosphate (CPP) crystals for pseudogout, in the joints of a patient by examining synovial fluid samples with a compensated polarized light microscope (CPLM). Compared to a standard bright-field light microscope, a CPLM has a pair of linear polarizers using the cross-polarized configuration, and a full-wave retardation plate (red compensator) to convert birefringence of the objects into color variations. MSU crystals have strong negative birefringence and needle-like shape i.e., the fast axis is along the axial direction of the crystal, which, when observed under a CPLM, appear yellow (or blue) when the MSU crystal is aligned parallel (or perpendicular) with the slow axis of the full-wave retardation plate, upon a red/magenta background color. On the other hand, CPP crystals have weak positive birefringence and rhomboid or rod-like shape. Although polarized microscopy has been considered as the “gold standard” for diagnosis of crystal arthropathy since 1961, recent studies show that joint aspiration is not regularly performed in primary care clinics. In some observational studies, only about 10% of primary care physicians performed polarizing microscope examination in diagnosing gout or pseudogout patients.

Among other reasons, limitations of the conventional lens-based microscopes play an important role. Most critically, conventional lens-based microscopes have relatively small field-of-view (FOV), especially when high-numerical aperture (NA) and high-magnification objective lenses are used. For example, in the identification of MSU crystals, routinely a 40× (e.g., 0.75NA) objective lens is used to observe the morphology of the crystals, resulting in an extremely small FOV (˜0.2 mm²) which leads to long examination times by diagnosticians. In particular, when there is only a limited number of crystals present in a synovial fluid sample taken from the patient, the examination of the entire sample can be not only time-consuming but also can produce a non-reliable diagnostic result because of operator-dependent bias in detecting the crystals over a limited FOV. The concentration of crystals directly correlates with diagnosticians' ability to positively identify crystals. Furthermore, the reliability of CPLM for detection of MSU and CPP crystals can vary widely depending on the examiner's level of training. Moreover, polarized light microscopes are bulky, heavy and expensive (e.g., $10,000 to $20,000 or more). These drawbacks of current methods and microscope devices call for a newer methods and systems to detect to detect crystal arthropathy such as MSU and CPP with higher-throughput, easier to use; and ideally automated.

### SUMMARY

In one embodiment, to address the limitations of the conventional lens-based polarized light microscopes, a lens-free microscope device has been developed that uses holographic imaging to produce high-resolution images of the deposited crystals contained in synovial fluid. A source of illumination generates light that is first passed through a first circular polarizer prior to reaching a sample contained on an optically transparent substrate such as a microscope slide. The light passes through a second polarizer and retarder film that are both interposed between the opposing side of the optically transparent substrate and an image sensor that is used to capture the holographic images of the sample. The captured holographic images of the birefringent crystals are then subject to computational reconstruction such as pixel super-resolution and multi-height phase recovery to generate reconstructed phase and amplitude images of the crystals. Images are obtained at different orientations or positions of the first polarizer and amplitude subtraction is performed on the reconstructed images which are used to identify or characterize crystals in the sample.

With ˜2 orders of magnitude larger FOV than a CPLM, the microscopy technique described herein has the potential to largely improve the efficiency and accuracy of crystal arthropathy, while also reducing costs. Furthermore, as the lens-free imaging set-up can be extremely compact, cost-effective and field-portable, the presented method is especially promising for automated diagnosis of crystal arthropathy at the point of care or in resource-limited clinical settings.

Lens-free computational microscopy addresses the efficiency and reliability issues of conventional crystal arthropathy diagnosis using the CPLM. However, the adaptation of the current bright-field lens-free microscopy setup to polarized imaging is not straightforward: the cross-polarized configuration used in CPLM can totally extinguish the background light that is not modified by the birefringent sample, and therefore is not applicable to lens-free holography where a reference light is necessary to form interference. Moreover, the color contrast of birefringent objects as generated by a conventional CPLM is challenging to replicate by a lens-free microscope which inherently uses narrow-band illumination sources, unless multiple wavelengths are used.

In one embodiment, a method of imaging a sample having birefringent crystals or birefringent materials using a lens-free polarized microscopy device includes illuminating the sample contained on a sample holder with circularly polarized partially coherent or coherent light and capturing lower resolution holographic images of the birefringent crystals with an image sensor. A polarization analyzer unit made from a λ/4 retarder and a linear polarizer is positioned between the sample holder and the image sensor. The polarization analyzer unit can be moved or rotated into different positions or orientations. The lower resolution holographic images are obtained with the polarization analyzer unit in two different orientations (e.g. ˜90° orientations with respect to one another). Phase-retrieved, higher resolution images of the birefringent crystals at the two different orientations are obtained using the lower resolution holographic images. For example, pixel super-resolution (PSR) and multi-height phase recovery may be used to obtain the higher resolution image. A differential image is generated from the respective phase-retrieved, higher resolution images. An object support mask is applied to identify the birefringent crystals which can then be pseudo-colored.

In another embodiment, a lens-free polarized microscopy device includes a light source emitting coherent or partially coherent light and a circular polarizer that receives light from the light source. An optically transparent sample holder holds the sample that contains the birefringent crystals or birefringent material and is disposed along an optical path that is positioned to receive the circular polarized light. The output light from the circular polarizer is located a distance (z₁) from the optically transparent sample holder. The device includes an image sensor disposed on an opposing side of the optically transparent sample holder and is positioned along the optical path, wherein an active imaging surface of the image sensor is located a distance (z₂) from the sample holder and z₂<<z₁. The microscopy device includes a mechanical stage configured to move the image sensor in the x, y, and z directions. A polarization analyzer unit that is formed from a λ/4 retarder and a linear polarizer is positioned between the sample holder and the image sensor. The polarization analyzer unit is moveable or rotatable between two orientations.

### BRIEF DESCRIPTION OF THE DRAWINGS

FIG. 1 illustrates one embodiment of a holographic microscope system that is used to image birefringent crystals that are contained in a sample.

FIG. 2 illustrates a sample containing birefringent crystals (or is suspected to contain them) that is loaded onto a sample holder.

FIGS. 3A and 3B illustrate one method used to reconstruct phase and amplitude images of a sample according to one embodiment.

FIG. 4 schematically illustrates the optical path taken by light from the light source through the sample and onto the image sensor. The polarization of the light along the optical path at various points is also illustrated.

FIG. 5 illustrates one embodiment of a method used to image birefringent crystals/materials.

FIG. 6A illustrates a top down view of the sample holder, polarization analyzer unit, and image sensor. The polarization analyzer unit is in the first orientation (0°).

FIG. 6B illustrates a top down view of the sample holder, polarization analyzer unit, and image sensor. The polarization analyzer unit is in the second orientation (90°).

FIG. 6C illustrates a mechanical stage according to one embodiment that may be used to rotate the polarization analyzer unit.

FIG. 7A illustrates a series of graphs illustrating optimization of the orientation angle of the linear polarizer (γ) for MSU crystals. The normalized output amplitude |\hat{p}| is plotted as a function of the sample fast-axis orientation, α, for different linear polarizer orientations (γ=50°, 55°, 65°, 75°). 65° was chosen as the optimum for MSU crystals. 50° was chosen as the optimum for CPP crystals.

FIG. 7B illustrates the simulated normalized output images of MSU crystals at varying orientations, using γ=65°. The MSU crystals are simulated as cylinders with a birefringence of |Δn|=0.1, diameter of 0.5 μm, length of 10 μm, and the fast axis is along the long axis of the crystals.

FIG. 8 illustrates simulated images of four different types of particles with the same needle-like morphology: negatively birefringent and transparent (first column, image panels (a), (b), (c)), positively birefringent and transparent (second column, image panels (d), (e), (f)), non-birefringent and transparent (third column, image panels (g), (h), (i)), non-birefringent and absorptive (fourth column, image panels (j), (k), (l)), imaged under two different analyzer orientations (0°: top row; 90°: middle row) and the subtraction of the amplitudes (labeled as differential) at these two orientations (lower row). The differential step (lower row) results in cancellation of non-birefringent particles that normally appear in both orientations of the polarization analyzer unit.

FIG. 9A illustrates a simulation of the differential output \hat{p}ₛ as a function of the relative phase retardation φ, with the crystals aligned at 45° (α=45°). \hat{p}ₛ almost linearly reaches to the maximum/minimum when increases from 0 to ˜0.22π, then turns backwards towards 0 as |φ| further increases to π.

FIG. 9B illustrates simulated images of a MSU crystal with larger diameter (2 μm) compared to FIGS. 7A and 7B. The effect of the nonlinearity is manifested by the hollow appearance of the simulated images. Nevertheless, the intense (bright/dark) edges provide enough contrast for crystal detection and identification.

FIG. 10 illustrates experimental lens-free imaging results of a MSU crystal sample from a patient's tophus, compared to a 40×0.75NA CPLM. Image panel (a) is the full FOV of the lens-free hologram is 20.5 mm² which is ˜2 orders of magnitude larger compared to the FOV of a typical 40× microscope objective lens (see dashed circle which represents typical 40× microscope FOV). Image panel (b) is a sub-region showing the lens-free differential polarized image. Clearly the crystals oriented close to 45° (see orientation guide in the bottom left of image panel (l)) appear brighter than the background, and those close to 135° appear darker. Image panels (c)-(e) are lens-free grayscale differential image of three ROIs taken from image panel (b). Image panels (f)-(h) are pseudo-colored images of image panels (c)-(e). Image panels (i)-(k) are 40×0.75NA CPLM images of the same regions as images (f)-(h). Short arrows: crystals that result in a weak signature have better contrast in the lens-free pseudo-color images (f, g) than the CPLM images (i, j). Long arrows: thick MSU crystals in the lens-free pseudo-color image (h) have hollow appearances, slightly different from the CPLM image (k).

FIG. 11 shows experimental imaging result of a steroid crystal sample, compared to a 40×0.75NA CPLM. Image panels (a), (d) are lens-free grayscale differential images of ROI 1 and ROI 2. Image panels (b), (e) are pseudo-colored images of image panels (a), (d). The longer arrows in (b) and (e) point to the glowing effect around crystals, resulting from the large thicknesses of the crystal particles. Image panels (c), (f) are 40×0.75NA CPLM images of the same regions as (b), (e). Image panels (g), (i) are the lens-free images of ROI 3 digitally refocused to the best relative focus distances (Δz) for different crystal particles, pointed by shorter arrows. Image panels (h), (j) are CPLM images corresponding to image panels (g), (i), manually refocused to the best focus distances for the respective particles pointed by white arrows.

FIG. 12 illustrates a large area of interest (approximately 2 mm²) lens-free differential hologram image captured with the microscopy system. Image panel (b) illustrates an enlarged sub-region of the dashed rectangular region from image panel (a). This enlarged sub-region of image panel (b) contains three ROIs (ROI 1, ROI 2, ROI 3) that are enlarged again and presented as panel images (c), (f) and (i). Panel image (c) is an enlarged lens-free differential view of ROI 1. Panel image (f) is an enlarged lens-free differential view of ROI 2. Panel image (i) is an enlarged lens-free differential view of ROI 3. Panel images (d), (g), and (j) illustrate CPLM images of the respective ROIs (ROI 1, ROI 2, ROI 3) with a 40×, 0.75 NA microscope using soft light. Panel images (e), (h), and (k) illustrate CPLM images of the respective ROIs (ROI 1, ROI 2, ROI 3) with a 40×, 0.75 NA microscope using linear light.

### DETAILED DESCRIPTION OF THE ILLUSTRATED EMBODIMENTS

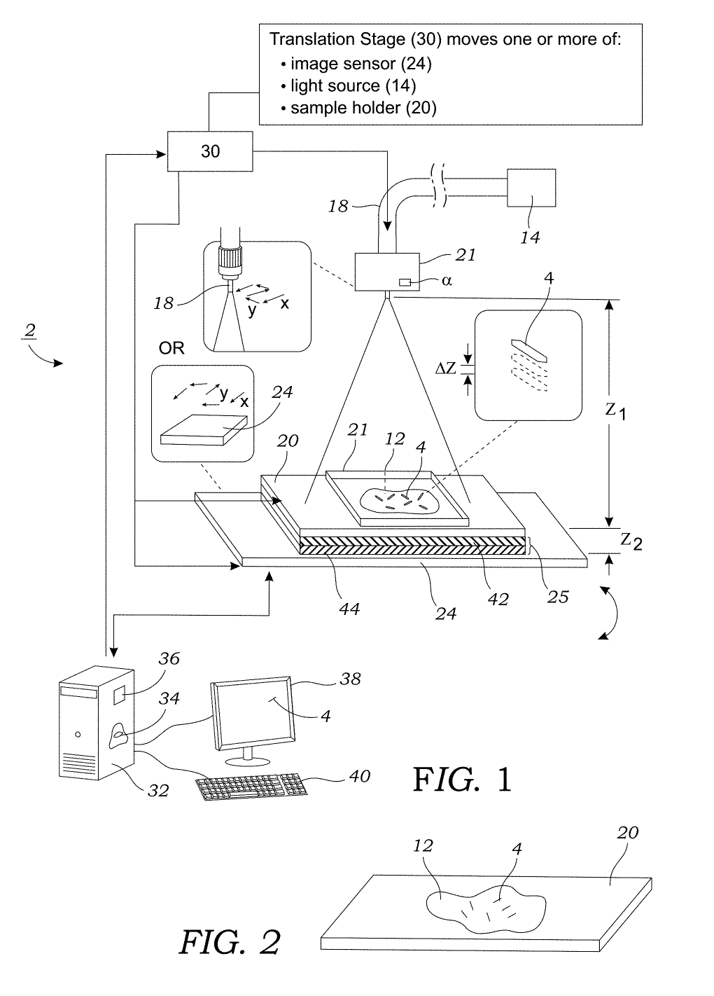

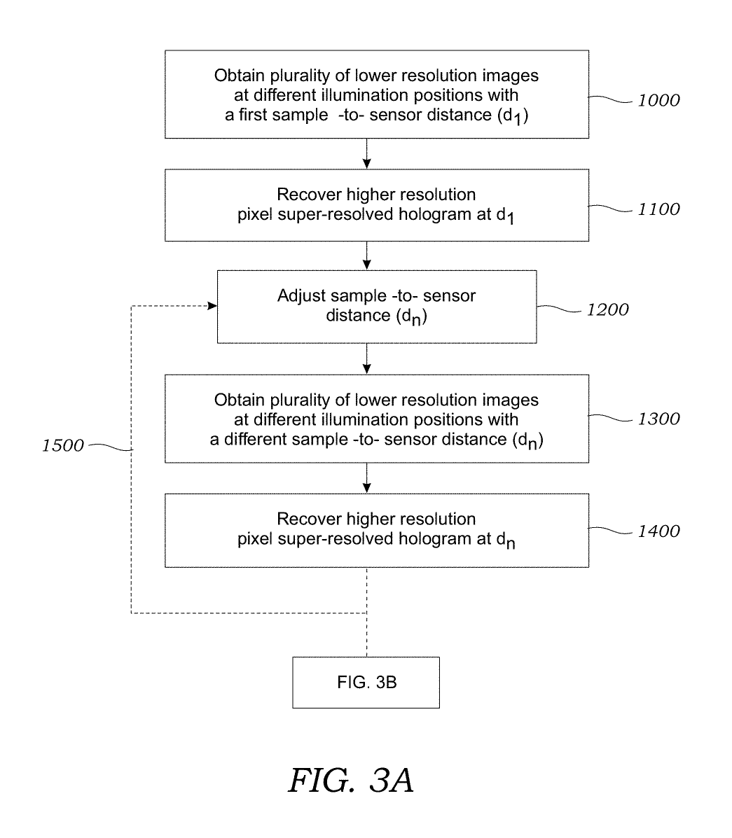

FIG. 1 illustrates one embodiment of a holographic microscope system 2 that is used to image birefringent crystals 4 (or other birefringent material) that are contained in a sample 12 (best seen in FIG. 2). The sample 12 may include, for example, a biological 12 sample that is obtained from a subject (e.g., mammalian subject). This may include any number of bodily fluids or body tissue. In one particular example, the sample 12 is synovial fluid that is obtained from the subject. To obtain the synovial sample, the needle of a syringe (not shown) is inserted into the joint area and a small amount of synovial fluid is withdrawn for testing. Only a small amount of synovial fluid is needed for testing (e.g., only enough to form a testing drop(s) on the sample holder 20 as described herein). The obtained synovial fluid is then spun in a centrifuge for several minutes (e.g., about five (5) minutes) to remove cells and debris. A small amount of the supernatant (e.g., one to several drops) is then transferred to the sample holder 20. The sample holder 20, in one embodiment, is a made from an optically transparent substrate such as glass or plastic (e.g., glass slide). After depositing the sample onto the sample holder 20, optionally, an optically transparent cover 21 (e.g., cover slide) is placed on the sample holder 20. In some embodiments, the sample holder 20 containing the sample 12 is imaged “wet.” In other embodiments, the sample holder 20 contains a dried sample and sealed with Cytoseal™ mounting media or the like. A dried sample, however, may require additional processing time to dry the fluid from the sample 12.

The birefringent crystals 4 that may be present in the synovial fluid (or other bodily fluid or tissues) include, for example, monosodium urate (MSU) crystals or calcium pyrophosphate (CPP) dihydrate crystals. The presence of MSU crystals in a synovial fluid sample 12 is used to diagnose gout in the subject. MSU crystals appear as needle-shaped crystals. When analyzed using a polarizing filter and red compensator filter, the MSU crystals appear yellow when aligned parallel to the slow axis of the red compensator but turn blue when aligned perpendicular across the direction of polarization (i.e., MSU crystals exhibit negative birefringence). The presence of CPP crystals in a synovial fluid sample 12 is used to diagnose pseudogout. CPP crystals are generally shorter than MSU crystals and may be either rod-like or rhomboidal in shape. Under a polarizing filter, CPP crystals exhibit positive birefringence; appearing blue when aligned parallel with the slow axis of the red compensator and yellow when oriented perpendicular.

Other crystals that can be formed in the mammalian body fluid or tissue besides MSU and CPP that cause or contribute to crystal-associated diseases, including but not limited to, crystal arthropathy, ureteral, or kidney stones caused by crystals among others, and exhibit birefringence may also be imaged using the methods and devices described herein. For example, urine may be examined for calcium oxalate crystals in subjects with kidney or ureteral stones. While the methods described herein are largely described in the context of imaging birefringent crystals 4 of biological origin, it should be understood that the methods and devices may also have applicability to imaging birefringent crystals 4 that are of non-biological origin. For example, birefringent crystal or material analysis may be used for material, mineralogical, or geological examination. Asbestos fibers are, for example, an example of a birefringent material. In yet another alternative, the birefringent crystal 4 may be synthetic, such as those that are synthesized. Thus, the sample 12 may be organic or inorganic in some embodiments.

Still referring to FIG. 1, the microscope system 2 is a lens-free microscope device that includes a light source 14, which in one embodiment is a broadband light source that emits partially coherent or coherent light, and is coupled to an optical fiber 18 (e.g., single mode fiber). In other embodiments, the light source could be a light source 14 with a narrow band such as, for instance, light emitting diodes (LEDs), laser diodes or the like. The optical fiber 18 is coupled to a circular polarizer 21. The circular polarizer 21 induces circular polarization of the light that travels along an optical path to the sample 12 contained on the sample holder 20. In one embodiment, the circular polarizer 21 is adjustable (e.g., using rotation via knob a) so that the total amount of illumination on the sample 12 can be adjusted. Generally, the circular polarizer 21 is set to maximize illumination power on the sample 12. As explained herein, this can be done by examining light intensity readout from the image sensor 24. Importantly, this alignment step does not need to be repeated for further imaging experiments if the illumination part remains unchanged, and for an unpolarized light source, no such alignment is necessary.

The lens-free microscope system 2 includes an image sensor 24 that is located adjacent to the underside of the sample holder 20. As explained below, a polarization analyzer unit 25 is positioned between the sample holder 20 and the image sensor 24. The image sensor 24 may be CMOS-based image sensor. The image sensor 24 may be a color sensor or a monochrome color sensor.

The distance between the output of the light from the circular polarizer 21 and the sample 12 referred to as the z₁ distance is generally on the order of several centimeters (e.g., ˜10-15 cm). The active surface (i.e., imaging surface) of the image sensor 24 is located a distance z₂ below the surface of the sample holder 20 that holds the sample 12 and is significantly smaller as compared to the z₁ distance (i.e., z₂<<z₁). The typical distance for the z₂ dimension is generally less than 1 mm and, in other embodiments, between about 100 μm to about 800 μm, and in other preferred embodiments within the range of about 600 μm to about 800 μm. The image sensor 24 in the lens-free microscope system 2 is used to capture holographic images of birefringent crystals 4.

With reference to FIG. 1, the lens-free microscope system 2 further includes, in one embodiment, a translation stage 30 that, in one embodiment, is coupled to the image sensor 24 and moves the image sensor 24 in the x, y (and optionally z) directions which lie in a plane that is substantially parallel with the active surface of the image sensor 24 or in the z direction which, as illustrated, is generally orthogonal to the plane of the active surface of the image sensor 24. Movement in the x and y directions is used to capture images of the sample 12 using pixel super-resolution. In order to generate super-resolved images, a plurality of different, lower resolution images are taken as the image sensor 24 is moved in small increments in the x and y directions. In another alternative embodiment, the optical fiber 18 (e.g., light source) is moved in small increments generally in the x and y directions by the translation stage 30. In yet another alternative, the sample holder 20 may be moved in small increments in the x and y directions. The translation stage 30 may, optionally, be automatically controlled using a computer 32, dedicated controller, or the like to control an actuating element. Manual control of the translation stage 30 is also an option. Any number of mechanical actuators may be used including, for example, a stepper motor, moveable stage, piezoelectric element, or solenoid. The translation stage 30 may also be manually-operated stage. Preferably, the translation stage 30 can move in sub-micron increments thereby permitting images to be taken of the sample 12 at slight x and y displacements.

In still another alternative embodiment, rather than move the optical fiber 18 in the x and y directions, a plurality of spaced apart illumination sources (e.g., an array of light sources not shown) can be selectively actuated to achieve the same result without having to physically move the optical fiber 18, circular polarizer 21, or image sensor 24. The small discrete shifts (either by movement or actuation of spatially separated light sources) parallel to the image sensor 24 are used to generate a pixel super-resolution hologram image. In addition to movement in the x and y directions, the translation stage 30 may also move the sample holder 20 and/or image sensor 24 in the z direction (i.e., orthogonal to x, y plane) so that images may be obtain at multiple heights. This enables multi-height phase recovery as described in more detail below.

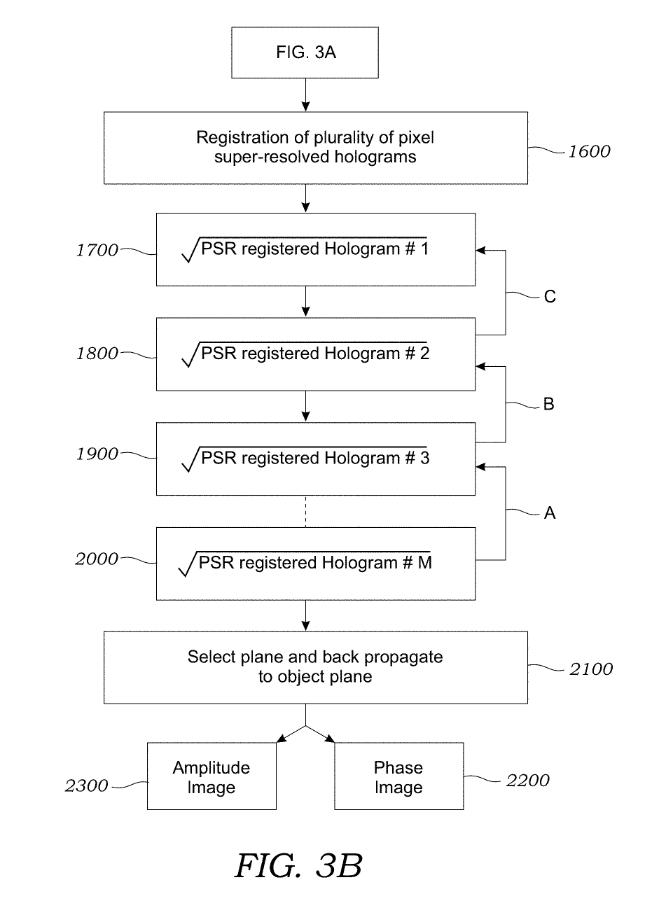

In the pixel super-resolution process, a plurality of lower resolution images are taken at different positions and are used to generate a computational image reconstruction that has a higher resolution. As seen in FIG. 3A, in step 1000, a plurality of lower resolution images are obtained of the sample 12 while the illumination source 14 (or optical fiber 18), sample holder 20, and/or the image sensor 24 are moved relative to another at a plurality of different locations (e.g., x, y locations) to create the sub-pixel image shifts (in the results described herein, the image sensor 24 was moved in the x and y directions). The number of lower resolution images may vary but generally includes between about 2 and 250 images. During step 1000, the sample 12 is located from the image sensor 24 at a first distance (d₁). Next, as seen in step 1100, a pixel super-resolved (PSR) hologram is synthesized based upon the plurality of lower resolution images obtained in operation 1000. The details of digitally converting a plurality of lower resolution images into a single, higher resolution pixel SR image may be found in Bishara et al., Lensfree on-chip microscopy over a wide field-of-view using pixel super-resolution, Optics Express 18:11181-11191 (2010), which is incorporated herein by reference. This pixel super-resolution step takes lower resolution holographic shadows of the birefringent crystals 4 contained within the sample 12 (e.g., captured at ˜10 million pixels each) and then creates a higher resolution lens-free hologram that now contains >300 million pixels over the same ˜20-30 mm² field-of-view with an effective pixel size of ˜300 nm.

Next, as seen in operation 1200, the distance between the sample 12 and the image sensor 24 is adjusted to a different distance (dₙ) (e.g., by adjusting z distance using translation stage 30). At this new distance (dₙ), as seen in operation 1300, a plurality of lower resolution images are obtained of the sample 12 containing the birefringent crystals 4 while the illumination source 14 (or optical fiber 18), sample holder 20, and/or the image sensor 24 are moved relative to another at a plurality of different locations (e.g., x, y locations) to create the sub-pixel image shifts. The plurality of lower resolution images are obtained while the sample 12 and the image sensor 24 are located at the new or different distance (dₙ). After the lower resolution images are obtained, as seen in operation 1400, a pixel super-resolved hologram (at the different distance (dₙ)) is synthesized based upon the plurality of lower resolution images obtained in operation 1300. As seen by arrow 1500, process is repeated for different sample-to-sensor differences. Generally, the process repeats such that a pixel super-resolved hologram is created at between 2-20 different distances although this number may vary.

Now referring to FIG. 3B, the plurality of pixel super-resolved holograms obtained at the different heights (i.e., different z distances) are then registered with respect to each other as seen in operation 1600. The subsequent iterative phase recovery requires that these pixel super-resolved holograms are accurately registered to each other. During the image acquisition step, lateral translation and rotation of the objects between holograms of different heights are unavoidable. To accurately register these pixel super-resolved holograms to each other, three-control points from three different corners of the image are selected in one of the holograms (which is deemed the reference hologram). One preferred control point could be a small isolated dust particle at a corner since its hologram is circularly symmetric. If need be, a special alignment marker(s) can also be placed at the corners of the sample holder/substrate. Therefore, normalized correlations between lens-free holograms can be used to find the matching points in each image captured at a different height. After selection of the control points, a small area (e.g., ˜30×30 μm) around each control point is cropped and digitally interpolated (˜4-6 times) to serve as a normalized correlation template. Furthermore, for accurately finding the coordinate shift of each control point among M images, lens-free holographic images have to be positioned in the same z₂-distance. Therefore, the difference in the z₂-distance between lens-free holograms acquired at different heights is evaluated by an auto-focus algorithm, such as that disclosed in J. L. Pech-Pacheco et al., “Diatom Autofocusing in Brightfield Microscopy: a Comparative Study,” in Pattern Recognition, International Conference On (IEEE Computer Society, 2000), Vol. 3, p. 3318, incorporated herein by reference, which permits one to digitally propagate the selected correlation templates to the same z₂-distance, where normalized correlations are calculated to find the coordinate shifts between the control points in each image. An affine transformation is used to register the super-resolved holograms of different heights to the reference hologram.

Still referring to FIG. 3B, operations 1700, 1800, 1900, and 2000 illustrate one embodiment of the iterative phase recovery process that is used to recover the lost optical phase. Additional details regarding the iterative phase recovery process may be found in L. J. Allen and M. P. Oxley, Optics Communications, 2001, 199, 65-75, which is incorporated herein by reference. The square roots of these resulting M registered holograms are then used as amplitude constraints in the iterative phase recovery algorithm that is steps 1700 through 2000. At the beginning of the algorithm, as seen in operation 1700, in one embodiment, the initial phase is assumed to be zero, after which the iterative phase recovery algorithm uses the free space propagation function to digitally propagate back and forth among these multiple heights. At each height, the amplitude constraint (i.e., the measurement) is enforced while the phase is kept from the previous digital propagation step.

To initiate the phase recovery process, a zero-phase is assigned to the object intensity measurement. One iteration during this phase-recovery process can be described as follows: Intensity measurement #1 (step 1700) is forward propagated (with zero initial phase) to the plane of intensity measurement #2 (step 1800). Then, the amplitude constraint in measurement #2 (step 1800) is enforced while the calculated phase resulting from forward propagation remains unchanged. The resulting complex field is then forward propagated to the plane of intensity measurement #3 (step 1900), where once again the amplitude constraint in measurement #3 is enforced while the calculated phase resulting from forward propagation remains unchanged. This process continues until reaching the plane of intensity measurement #M (step 2000). Then instead of forward propagating the fields of the previous stages, back propagation is used as seen by respective arrows A, B, and C. The complex field of plane #M (step 2000) is back propagated to the plane of intensity measurement #M−1. Then, the amplitude constraint in measurement #M−1 is enforced while the resulting phase remains unchanged. The same iteration continues until one reaches the plane of intensity measurement #1 (step 1700). When one complete iteration is achieved (by reaching back to the plane of intensity measurement #1), the complex field that is derived in the last step will serve as the input to the next iteration. Typically, between 1-1,000 iterations and more typically between 1-70 iterations are required for satisfactory results. After the phase recovery iterations are complete, as seen in operation 2100, the acquired complex field of any one of the measurement planes is selected and is back propagated to the object plane to retrieve both phase image 2200 and amplitude image 2300 of the sample 12.

Referring back to FIG. 1, the system 2 includes a computer or computer device 32 such as a server, laptop, desktop, tablet computer, portable communication device (e.g., Smartphone), personal digital assistant (PDA) or the like that is operatively connected to the system 2 such that lower resolution images (e.g., lower resolution or raw image frames) are transferred from the image sensor 24 to the computer 32 for data acquisition and image processing. The computer 32 includes one or more processors 34 that, as described herein in more detail, runs or executes image processing software 36 that takes multiple, sub-pixel (low resolution) images taken at different scan positions (e.g., x and y positions as seen in inset of FIG. 1) and creates a single, high resolution projection hologram image of the birefringent crystals 4. The software 36 creates additional high resolution projection hologram images of the birefringent crystals 4 at each different z₂ distance. The multiple, high resolution images obtained at different heights are registered with respect to one another using the software 36. The software 36 also digitally reconstructs complex projection images of the birefringent crystals 4 through an iterative phase recovery process that rapidly merges all the captured holographic information to recover lost optical phase of each lens-free hologram without the need for any spatial masking, filtering, or prior assumptions regarding the samples. After a number of iterations (typically between 1 and 75), the phase of each lens-free hologram (captured at different heights) is recovered and one the pixel super-resolved holograms is back propagated to the object plane to create phase and amplitude images of the sample 12 including birefringent crystals 4 contained therein.

The computer 32 may be associated with or contain a display 38 or the like that can be used to display images that are generated in accordance with the methods described herein. These may be greyscale images or pseudo-color images of the birefringent crystals 4. The user may, for example, interface with the computer 32 via an input device 40 such as a keyboard or mouse to select different software functions using a graphical user interface (GUI) or the like. It should be noted that the method described herein may also be executed in a cloud-based processing operations. Image data could be sent to a remote computer 32 (e.g., remote server) for processing with a final image being generated remotely and sent back to the user on a separate computer 32 or other electronic device (e.g., mobile phone display) for ultimate display and viewing. Image and other data may be transferred over a wide area network such as the Internet or a proprietary communication network (like those used for mobile devices).

Referring back to FIG. 1, the microscopy system 2 includes a polarization analyzer unit 25 that converts the refracted, circular polarized light to linearly polarized light. The polarization analyzer unit 25, in one preferred embodiment, includes a λ/4 retarder 42 and a linear polarizer 44 that are formed as a single, unitary structure. In one preferred embodiment, the λ/4 retarder 42 is in the form of a thin film (thickness of tens to hundreds of micrometers) and the linear polarizer 44 is also in the form of a thin film (thickness of tens to hundreds of micrometers) that are bonded together using, for example, a UV-curable adhesive. For example, the λ/4 retarder 42 may be formed from a retarder film such as 75 μm thick film available from Edmund Optics, Inc. (Stock #88-252). The linear polarizer 44 may be formed from a retarder film such as 180 μm thick film available from Edmund Optics, Inc. (Stock #86-180). The λ/4 retarder 42 and the linear polarizer 44 are advantageously made thin to fit within the small gap between the sample holder 20 and the image sensor 24. Immersion oil may be provided between the image sensor 24 and the polarization analyzer unit 25. The immersion oil mitigates interference fringes caused by the thin air gap between the polarization analyzer unit 25 and the surface of the image sensor 24.

Importantly, the angle at which the λ/4 retarder 42 and a linear polarizer 44 are bonded to one another is optimized for the particular birefringent crystals 4. For example, it was found that, for MSU birefringent crystals 4, the linear polarizer film 44 should be optimally angled relative to the λ/4 retarder film 42 with a linear polarizer 44 orientation of around +65°. That is to say, if the λ/4 retarder film 42 has its long side parallel to the x axis, the linear polarizer film of the 44 is angled at around 65° with respect to the x axis. For CPP birefringent crystals 4, it was found that the linear polarizer film 44 should be optimally angled relative to the λ/4 retarder film 42 with a linear polarizer 44 orientation of around +50°. Thus, in one embodiment of the invention, the linear polarizer film 44 should be angled relative to the λ/4 retarder film 42 with a linear polarizer 44 orientation within the range of about +40° to about +60°. While CPP birefringent crystals 4 are visible where the polarizer analyzer angle-mismatch is +65° (i.e., MSU optimization), by setting the angle-mismatch to +50°, enhancement of the weaker CPP birefringent crystals 4 is improved. However, at 50° MSU birefringent crystals 4 lose some of their birefringent intensity. For viewing MSU birefringent crystals 4 the angle-mismatch should be in the range of about 55° to about 75° with 65° being preferred as described herein.

In one embodiment, different polarization analyzer units 25 may be provided for different birefringent crystals 4. For example, a polarization analyzer unit 25_{MSU} may be created that is optimized for identifying MSU birefringent crystals 4. Another polarization analyzer unit 25_{CPP} may be created that is optimized for identifying CPP birefringent crystals 4. These different polarization analyzer units 25_{MSU}, 25_{CPP} can be swapped in and out of the microscopic imaging system 2 to look for specific birefringent crystals 4. In another embodiment, a single polarization analyzer unit 25 may be used. In this embodiment, the angle-mismatch may be provided somewhere in between the optimal angle for MSU and CPP crystals (e.g., ˜58°).

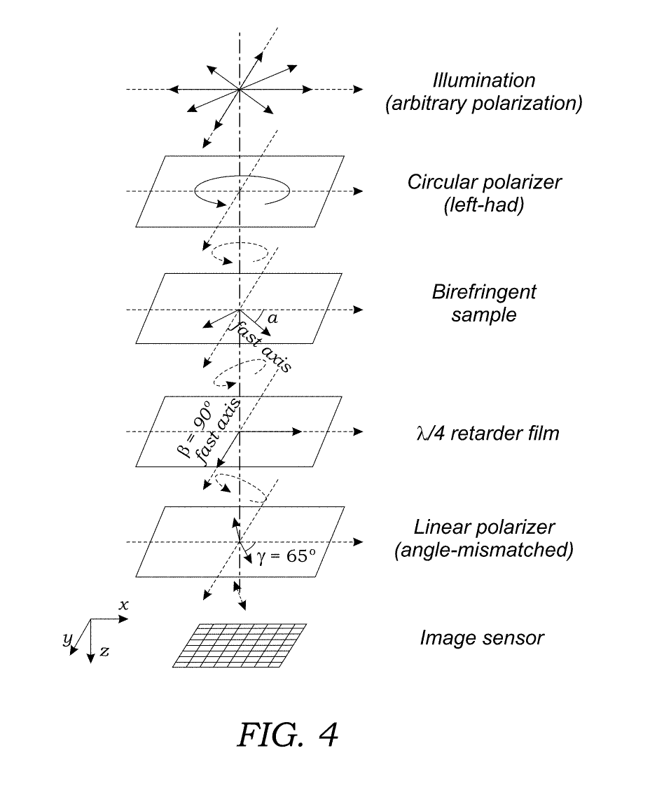

FIG. 4 illustrates the optical path taken by light from the light source 14. Light from the light source 14, which may have an arbitrary polarization, passes through the circular polarizer 21. As seen in FIG. 4, the light then has left-hand circular polarization. This light then passes through the sample 12 containing birefringent crystals 4 which effectuates elliptical polarization of the light. The light then passes through the λ/4 retarder film 42 and the angle-mismatched linear polarizer film 44 to create linear polarized light that then illuminates the image sensor 24.

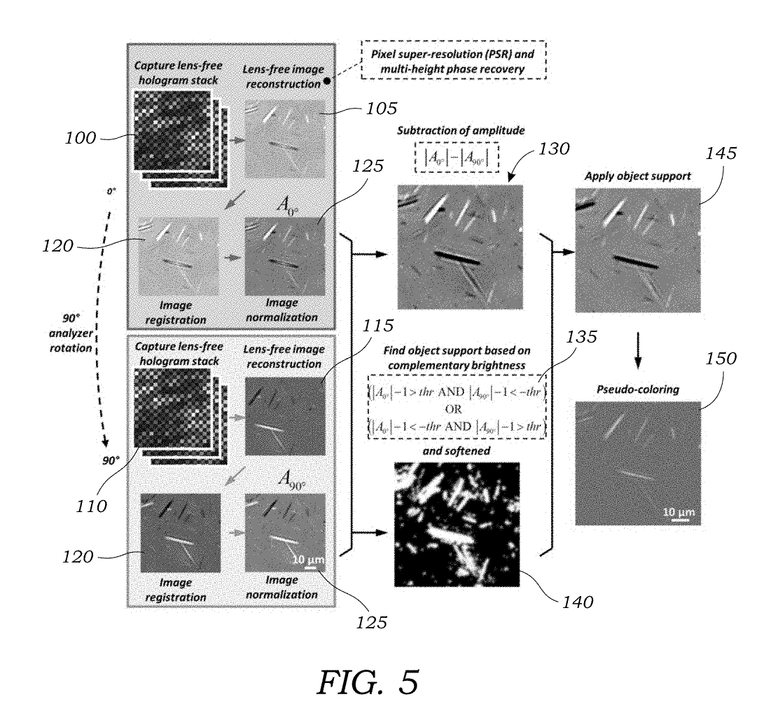

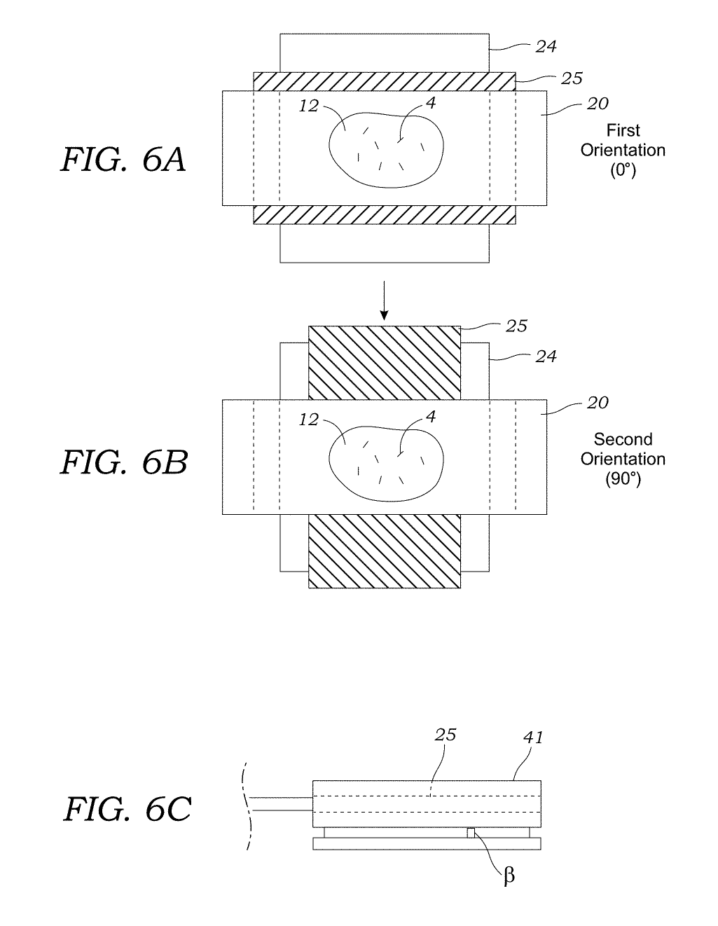

FIG. 5 illustrates one embodiment of a method used to image birefringent crystals 4. As explained herein, the imaging process uses two different orientations of the different polarization analyzer unit 25. A lens-free, reconstructed image of the sample 12 containing the birefringent crystals 4 is obtained with the polarization analyzer unit 25 in a first orientation (e.g., 0°). Another lens-free, reconstructed image of the sample 12 containing the birefringent crystals 4 is obtained with the polarization analyzer unit 25 in a second orientation that is angled about 90° with respect to the first orientation (e.g., 90°). This rotation of the polarization analyzer unit 25 is used, as explained herein, in a subtraction operation to remove artifacts from the lens-free images. With reference to FIG. 5 and the polarization analyzer unit 25 located in the first orientation (0°), in operation 100 a plurality of low-resolution hologram images of the sample 12 is obtained using pixel super-resolution techniques to move, for example, the image sensor 24 in small sub-pixel movements in the x and y directions so that a higher resolution holographic image can be generated. In addition, these lower resolution hologram images are obtained at different heights (z) so that the lost phase may be recovered using multi-height phase recovery as described herein. Operation 105 in FIG. 5 illustrates the lens-free reconstructed image of a FOV of a sample containing birefringent crystals 4. In this example, pixel super-resolution (PSR) and multi-height phase recovery were used to generate the higher resolution, digitally recovered image of the sample 12. With reference to operation 110, the polarization analyzer unit 25 is then moved (e.g., rotated) to the second orientation (90°) and a plurality of low-resolution hologram images of the sample 12 is obtained using pixel super-resolution techniques to move the image sensor 24 in small movements in the x, y, and z directions so that a higher resolution holographic image can be generated. FIGS. 6A and 6B illustrate the rotation of the polarization analyzer unit 25 from the first orientation (0°) to the second orientation (90°). FIG. 6C illustrates one example of a mechanical stage 41 that contains the polarization analyzer unit 25 therein and is able to quickly rotate the polarization analyzer unit 25 using a knob β. Of course, in some embodiments, there is no need for a separate mechanical stage 41 as the polarization analyzer unit 25 could just be manually rotated.

Operation 115 illustrates the lens-free reconstructed image of a FOV of a sample containing birefringent crystals 4 after rotation of the polarization analyzer unit 25. Because differential imaging is used to subtract image amplitudes, image registration is performed to match to high resolution lens-free reconstructed images in the 0° orientation and the 90° orientation. Image registration is seen in FIG. 5 in operation 120. This may be performed using imaging processing software 36 to match features in the images and calculate or generate a geometric transformation between the two sets of complex images. This may be performed using, for example, the Computer Vision System Toolbox™ of MATLAB®. Next, with reference to operation 125 in FIG. 5, both the 0° and 90° complex images after image registration are divided by their respective mean values, such that the discrepancy between their brightness is minimized (e.g., image normalization). Amplitude subtraction is then performed to generate a differential image as seen in operation 130 of FIG. 5. This process is performed to remove artifacts from the lens-free, reconstructed images of the sample 10. With reference to operation 135 of FIG. 5, an object support mask is then created for the birefringent objects (e.g., crystals 4) within the sample 10. This object support mask is then softened using a Gaussian function as illustrated in operation 140 of FIG. 5. The softened object support mask is then used with the amplitude subtracted image Aₛ to create a grayscale differential image A_{M} as illustrated in operation 145 of FIG. 5. The grayscale differential image is then mapped into a pseudo-color image as seen in operation 150 of FIG. 5 to create a similar color contrast compared to that achieved using conventional CPLM imaging for the ease of a rheumatologist or other trained technician to inspect the sample image.

While reference is made to rotating the polarization analyzer unit 25 by approximately 90° it should be understood that the amplitude subtraction process works even if the rotation is somewhat off of 90°. For example, without limiting the scope of the invention, a rotation within the range of 90°±15° will still remove or reduce absorptive objects. Useful results may even be obtained for angle orientations that fall outside the above-noted range. In addition, while the experiments described herein describe the polarization analyzer unit 25 being rotated the same result could be achieved by bonding or adhering the analyzer unit 25 to the image sensor 24 and rotating the sample holder 20 between the two imaging runs.

### EXPERIMENTAL

The holographic microscope system 2 illustrated in FIG. 1 was used to image synovial fluid samples of subjects to image MSU and CPP crystals.

### Lens-Free Polarized On-Chip Imaging Setup

A broad band source (WhiteLase-Micro, Fianium Ltd, Southampton, UK) was used to provide illumination at a wavelength of 532 nm, with a spectral bandwidth of ˜2.5 nm and an optical power of ˜20 μW. Note that, as explained herein, in other embodiments, the light source could be a narrow band light source such as LEDs or laser diodes or the like. The source is coupled to a single-mode optical fiber and the light is emitted at the end of this fiber without any collimation, as shown in FIG. 1. A circular polarizer was mounted in a 3D-printed rotatable holder and was attached to the optical fiber as illustrated in FIG. 1, such that the light first passes through the circular polarizer. Approximately 10 cm (z₁ distance) under the illumination fiber tip, a microscope slide with a drop of synovial fluid (dried) was held in place by a 3D-printed slide holder. A CMOS image sensor (Sony, IMX081, 1.12 μm pixel size) with the polarization analyzer unit (laminated films) on top was placed under the sample and is connected to a 3D positioning stage (Thorlabs, NanoMax 606) for x-y-z movement to achieve PSR and multi-height based phase recovery. The analyzer film is directly placed on top of the image sensor with immersion oil in between. The immersion oil mitigates interference fringes caused by the thin air gap between the analyzer and the image sensor surfaces. The distance between the CMOS image sensor photosensitive layer to the sample (z₂ distance) is ˜600 μm.

Before image acquisition, the orientation of the circular polarizer is rotated manually to maximize the total illumination power on the sample by observing the histogram of the live readout from the image sensor. This alignment step does not need to be repeated for further imaging experiments if the illumination part remains unchanged, and for an unpolarized light source, no such alignment is necessary.

At the first stage of the image acquisition, the long side of the polarization analyzer unit is aligned with the long side (i.e., horizontal direction) of the image sensor chip. After PSR and multi-height hologram acquisition, the polarization analyzer unit is rotated by 90° and the same PSR and multi-height hologram acquisition process is repeated. As noted herein, rotation does not need to be exactly 90° because good subtraction results may be obtained with other angled orientations. Since the rotation of the analyzer is equivalent to the rotation of the sample, in an alternative design, one can permanently bond the polarization analyzer unit to the image sensor and rotate the sample between the two imaging runs.

### Fabrication of the Analyzer Unit Using Low-Cost Polymeric Polarizing and Retardation Films

A 1.8 cm-by-1.5 cm piece of λ/4 retarder film (75 μm thickness, Edmund Optics, Inc., Barrington, N.J.) is cut out from a larger sheet, with the long side parallel to the slow axis. A piece of linear polarizing film (180 μm thickness, Edmund Optics, Inc., Barrington, N.J.) of the same dimensions is cut, with the long side at 65° with respect to the polarization direction (for MSU crystals). Then the two pieces are aligned and bonded together using ultraviolet (UV)-curable adhesive (NOA 68, Norland Products, Cranbury, N.J.) with the λ/4 retarder on top (i.e., closer to the sample), and cured under a UV lamp.

### Fabrication of the Circular Polarizing Unit

In general, for an unpolarized light source, a piece of circular polarizer placed in front of the light source is sufficient to generate circularly polarized light, without the need for alignment. However, in the experimental set-up the light generated by the tunable illumination source is close to linearly polarized light. Therefore, the orientation of the circular polarizer in the set-up translates into output light intensity variations. To better utilize the power of the illumination source, a 3D-printed rotatable holder was designed for the circular polarizer to achieve free manual rotation with a range of 180°. First, a circular polarizer piece is cut from a larger sheet (left-handed plastic circular polarizer, Edmund Optics, Inc., Stock #88-087), and is glued to a 3D-printed rotary piece with a handle. Then the rotary piece is placed inside a 3D-printed outer shell with openings on the top and at the bottom, and with tick marks for 10° increments. Finally an optical fiber holder is embedded inside the same outer shell, on top of the rotary piece.

### Processing of Lens-Free Polarized Images

As depicted in FIG. 5, after PSR and multi-height-based phase recovery and image reconstruction of the two hologram stacks with the analyzer unit undergoing a 90° rotation in between, two sets of reconstructed complex images of the crystals are obtained. In order to combine them into a single lens-free polarized image with pseudo color-contrast, the following steps are sequentially applied:

(1) Image registration. The automated feature-matching algorithm in the Computer Vision System Toolbox™ of MATLAB® was used to calculate a geometric transform between the two sets of complex images assuming a similarity relationship, based on which the 90° image is aligned to the 0° image. Note that this feature matching requires that the inputs are real-valued images. Therefore, the absolute-background-subtracted versions of the two complex images was used for feature extraction purposes:

Oⱼ³=|Oⱼ−Ōⱼ| (1)

where Oⱼ(j={0°, 90°}) denotes the two complex images to be aligned, Ōⱼ denotes the mean value of Oⱼ.

(2) Image normalization. Both the 0° and 90° complex images after image registration in step (1) are divided by their respective mean values, such that the discrepancy between their brightness is minimized. This step results in two normalized complex images

Aⱼ(j={0°, 90°}).

(3) Subtraction of image amplitudes. Next, one calculates Aₛ=|A_{0°}|−|A_{90°}|, resulting in a differential image Aₛ whose values are centered around 0.

(4) Birefringent object support calculation. To further exploit the information about the object support, i.e., the specific positions and maps of birefringent objects within the sample FOV, the complementary brightness property of this optical design is advantageously leveraged, where the brighter-than-background pixels caused by birefringence in the 0° image will roughly correspond to darker-than-background pixels in the 90° image, and vice versa. Based on this, the object support mask (M) for birefringent objects in the imaging FOV can be calculated using the following binary operation:

M=(|A_{0°}|−1>thr AND |A_{90°}|−1<-thr)

OR

(|A_{0°}|−1>-thr AND |A_{90°}|−1<thr) (2)

where thr is a predefined threshold value, e.g., 0.1, AND and OR refer to pixel-wise logical operators. The object support mask is then softened using a Gaussian function with σ=0.56 μm, resulting in a new mask:

$${M}_{b} = M * \frac{1}{\sqrt{2 π} σ} {e}^{- \frac{{x}^{2} + {y}^{2}}{2 {σ}^{2}}} \qquad ( 3 )$$

where * denotes two-dimensional convolution operation.

(5) Application of object support. After the calculation of the birefringent object support mask M_{b}, a grayscale differential image is then created, A_{M}=Aₛ ∘M_{b}, where ∘ denotes pixel-wise multiplication of two images.

(6) Pseudo-coloring of the lens-free image. In this final step, the grayscale differential image A_{M} is mapped into a color image C to create a similar color contrast compared to a conventional CPLM image for the ease of a rheumatologist to inspect the lens-free images. This color map is statistically learned using a sample lens-free grayscale differential image from step (5) and a corresponding CPLM image (40×0.75NA) of the same sample. First these two images (lens-free and CPLM) are aligned with respect to each other using image registration. Then, a set of 128 bins are created for the sample lens-free grayscale differential image, spanning the entire range of its values:

binₖ=[a+(k−1)w, a+kw) (4)

where k=1, . . . , 128, a is the minimum value of the sample lens-free grayscale differential image (A_{M}), and a+128w is equal to the maximum value of A_{M}. For each one of these bins, the following is then performed:

a) Find the set of pixels in the sample lens-free grayscale differential image that fall into the kth bin.

b) For this set of pixels found in step (a), find the corresponding pixels in the sample CPLM image, and calculate the mean R, G and B values for these pixels.

After steps (a) and (b), the mapping between the pixel values of the sample lens-free differential image with respect to the R, G and B components of the corresponding CPLM image is created. Finally, a piecewise linear function is used to approximate these three mapping functions (for R, G and B channels) to avoid rapid fluctuations due to insufficient sampling. For values that can potentially occur outside the range of these bins, linear extrapolation method is used.

### PSR Technique to Improve the Resolution of Lens-Free On-Chip Microscopy

The pixel size of the image sensor imposes a physical limit on the resolution of a lens-free on-chip microscope, according to the Nyquist sampling theorem. The PSR technique is applied to break this undersampling related resolution limit by capturing multiple subpixel-shifted low-resolution holograms and synthesizing them into a single high-resolution hologram. During the lens-free hologram acquisition, a positioning stage is used to shift the image sensor chip on an 8-by-8 orthogonal grid (x and y directions) with a grid size of 0.28 μm. Note that these subpixel shifts do not need to be precise or known a priori, as a digital shift estimation algorithm can be used to accurately estimate these sub-pixel shifts after image capture. Details regarding the estimation algorithm may be found in Bishara et al., discussed herein, which is incorporated herein by reference. Then a conjugate-gradient-descent method is used to find the optimal high-resolution hologram that is statistically consistent with all the low-resolution pixelated holograms that are undersampled at the sensor array.

### Digital Propagation of an Optical Wavefront Using the Angular Spectrum Method

If the complex wavefront of an optical field is known, which includes its amplitude and phase information, one can digitally calculate its propagation for a given distance using the angular spectrum method. The complex field is first Fourier-transformed to the angular spectrum domain using a fast Fourier transform (FFT) algorithm. Then an optical phase function is calculated, parameterized by the wavelength, index of refraction of the medium, and the distance of the digital propagation. The multiplication of the angular spectrum of the original optical field and the calculated phase function is inverse Fourier transformed to the spatial domain, yielding the digitally propagated complex optical field.

### Autofocus Algorithm to Identify the Sample Height on the Image Sensor

An autofocus algorithm is used to automatically find the z₂ distance (i.e., the sample-to-sensor distance) for a PSR hologram by solving a maximization problem, with the objective function being a focus criterion, and the variable being the propagation distance. The focus criterion used herein is the negative of the Tamura coefficient calculated for the amplitude of the complex image, which is found to give a distinct peak at the correct z₂ distance. The hologram is digitally propagated to a range of z₂ distances with the focus criterion evaluated at each height, and the corresponding maximum is found. Next, a smaller range of z₂ distances are evaluated around this maximum point, with the scanning resolution also refined. These steps are repeated until the scanning resolution falls below a predefined threshold (e.g., 0.01 μm).

### Multi-Height Phase Recovery for Elimination of Twin-Image Artifact

A multi-height iterative phase recovery algorithm with ten heights (z direction) is used to retrieve the optical phase of the holograms, in order to mitigate the twin image artifact caused by the loss of phase information at the sensor array. These heights are separated by ˜15 μm. An initial guess of the complex optical wave is calculated using the back-propagation of the hologram at the first measurement height, assuming that the heights are ordered in ascending order (i.e., the closest z₂ corresponds to the first height). Then, this initial guess is propagated to the second height, where its amplitude is averaged with the square root of the measured hologram at the second height, and the phase is kept unchanged. Next, this updating process is repeated at the subsequent heights and then backwards after it reaches the last height. Each one of these digital round-trips among these different heights counts as one iteration, and after ˜10-20 iterations the optical phase converges, yielding a unique complex wave for each one of the measurement heights. The converged complex wave of any one of these heights is finally propagated to the plane of the sample to obtain the complex image of the sample. Note that the transport of intensity equation (TIE) is not used here as it is known that TIE is more sensitive to low-frequency components, whereas the multi-height based iterative phase recovery is more sensitive to high-frequency components. Because the birefringent crystals of interest in synovial fluid are relatively small and sharp, the multi-height iterative phase recovery converges rather quickly without the need for using a solution of TIE.

### Preparation of MSU, CPP, and Steroid Crystals

The reference slides containing MSU or CPP crystals were anonymously prepared from a surgically resected large tophus without a link to any subject related information. The tophus was obtained when a patient with confirmed gout or CPP disease received resection surgery of the tophus located in the olecranon bursa. The surgery was routine elective surgery to alleviate the symptom, as part of standard clinical care and unrelated to this study. The tophus was cut in half, revealing a soft semi-liquid center. A smear sample was prepared (touch-prep method), and a small amount of adhesive mounting medium (Cytoseal™, Richard Allan Scientific, Kalamazoo, Mich.) was applied onto the sample. Finally, the slide was cover-slipped.

For the slides of steroid crystals (used as negative control sample), a mixture of methylprednisolone acetate suspension (Depo-Medrol® 40 mg/ml, Pfizer, New York) and 1 cc of 1% lidocaine was made. Twenty microliters of this mixture was placed onto a slide and smeared, and then air-dried. Adhesive mounting medium was not used for the steroid crystals slides, because applying the medium to steroid crystals had a tendency of creating bubbles next to the crystals, which was not observed in the MSU or CPP sample preparation.

All biologic samples were obtained after de-identifying the patients' information. The methodology for obtaining these samples was reviewed by UCLA Institutional Review Board (IRB) and deemed exempt.

### Design, Numerical Simulation and Analysis of Lens-Free Polarized On-Chip Microscopy for Imaging Birefringent Crystals

In order to model the optical design described herein, one can effectively decompose the presented lens-free polarized imaging system into two sections that deal with polarization and diffraction. In the polarization related part, the circular polarizer, birefringent sample and the analyzer are assumed to be thin and the vertical gaps between these components are assumed to be negligible. In the diffraction part, the light that exits the analyzer diffracts to be sampled by the image sensor, after a propagation distance of z₂. The polarization part of this lens-free on-chip imaging system was modeled using Jones calculus and simulated it in MATLAB®. The Jones representation of the respective elements of the imaging system can be written as:

a) Input left-hand circularly polarized (LHCP) light:

$$W = \frac{1}{\sqrt{2}} [ \begin{matrix}1 \\ - i\end{matrix} ] \qquad ( 5 )$$

where i=\sqrt{−1}.

Particular attention should be paid to the convention of handedness: the LHCP used in herein is defined from the point of view of the source, i.e., if one looks away from the source, along the direction of light propagation, the temporal rotation of the field at a given point in space is counterclockwise.

b) Birefringent sample:

$$S = [ \begin{matrix}{e}^{- i ϕ / 2} {cos}^{2} α + {e}^{i ϕ / 2} {sin}^{2} α & ( {e}^{- i ϕ / 2} - {e}^{i ϕ / 2} ) cos α sin α \\ ( {e}^{- i ϕ / 2} - {e}^{i ϕ / 2} ) cos α sin α & {e}^{- i ϕ / 2} {sin}^{2} α + {e}^{i ϕ / 2} {cos}^{2} α\end{matrix} ] \qquad ( 6 )$$

where φ is the relative phase retardation induced by the object birefringence after the sample plane, and α is the orientation of the fast axis of the birefringent sample with respect to the x-axis.

c) λ/4 retarder:

$$Q = {e}^{- i π / 4} [ \begin{matrix}{cos}^{2} β + i {sin}^{2} β & ( 1 - i ) sin β cos β \\ ( 1 - i ) sin β cos β & {sin}^{2} β + i {cos}^{2} β\end{matrix} ] \qquad ( 7 )$$

where β is the orientation of the fast axis of the λ/4 retarder with respect to the x-axis.

d) Linear polarizer:

L=[cos γ sin γ] (8)

where γ is the polarization orientation of the linear polarizer with respect to the x-axis. Note that one can write L as a row vector instead of a 2-by-2 matrix, such that p=LQSW can be a scalar complex output.

Based on these definitions, the variables of interest in the lens-free optical design for polarization imaging are α, β, γ, and φ. In simulations, the shape of the MSU was approximated crystals as a cylinder. It was further assumed that the lower bound on the diameter of the MSU crystal is 0.5 μm, and the lower bound on the birefringence is |Δn|=0.1 with the fast axis being the axis of the cylinder; therefore the relative birefringence induced phase retardation at the center of the cylinder at a wavelength of 532 nm can be approximated as φ˜0.19π. As the incident wave is circularly polarized, without loss of generality, β was selected to be equal to 90°. In order to detect birefringence as well as its sign (+/−) similar to a CPLM image, ideally the brightness in the output image should vary when the MSU crystal takes different orientations in the sample FOV. More specifically, when the MSU crystals are aligned with a certain direction, the output should appear brighter than the background; when perpendicular to the same direction, the output should appear darker than the background. In this way, if the sign of the birefringence changes, the brightness variation will invert, helping to determine the sign of the birefringence of the sample.

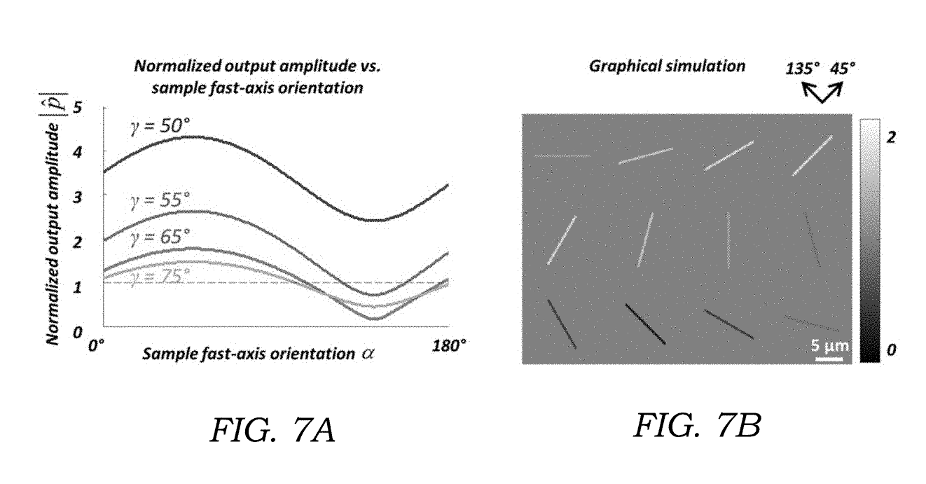

With these in mind, the remaining two parameters α and γ were scanned, and calculated the normalized output (\hat{p}) against a while varying γ, i.e.:

$$\hat{p} = \frac{p}{{p}_{0}} = \frac{LQSW}{LQIW} = \frac{LQSW}{LQW} \qquad ( 9 )$$

where in the calculation of p₀, the Jones matrix of the birefringent sample is replaced by the identity matrix I representing no sample being present. As can be seen in FIG. 7A, all the curves corresponding to different choices of γ exhibit a modulation of |\hat{p}| as a function of α, and the maximum values of these curves occur at α=45° while the minimum values occur at α=135°. Among all of these curves shown in FIG. 7A, the curve representing γ=+65°, has the largest modulation depth, implying the best sensitivity for the current parameters simulated (for MSU crystals). Moreover, the +65° curve is almost symmetrically distributed around unity, and thus, the brighter-than-background orientations of the MSU crystal roughly correspond to 0°<α<90°, whereas the darker-than-background orientations of the MSU crystal roughly correspond to 90°<α<180°. This feature is advantageous to the determination of the sign of the birefringence of the objects which is important for gout diagnosis and inspection of synovial fluids, and therefore in the experimental design, γ was chosen at +65° as the optimal configuration. Based on this choice, FIG. 7B also shows the graphical simulation of the image of a 0.5 μm diameter MSU crystal having different orientations: as expected, the crystal brightness is maximum when aligned in the 45° direction, and minimum when aligned in the 135° direction.

Next, simulations were run on the behavior of four different types of objects with the same cylindrical morphology with a diameter of 0.5 μm: (1) Transparent and negatively birefringent (φ=0.19π, fast axis is along the cylinder axis); (2) Transparent and positively birefringent (φ=0.19π, fast axis is perpendicular to the cylinder axis); (3) Transparent and non-birefringent (φ=0); (4) Absorptive and non-birefringent (φ=0 and transmission light intensity is attenuated by 36% per micron).

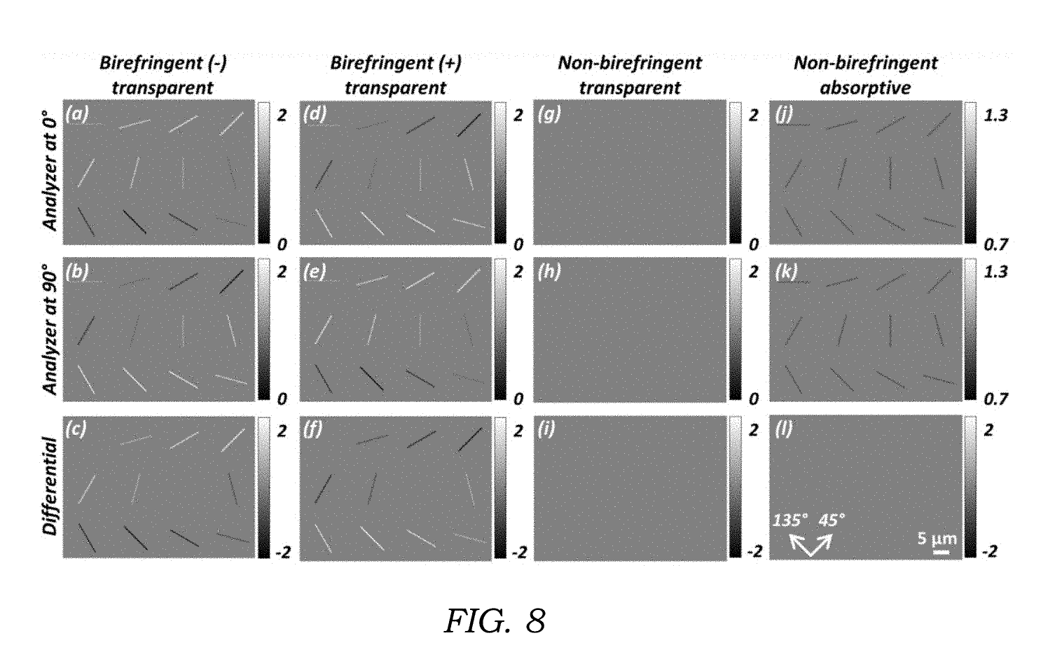

These numerical simulations were performed to better understand how different target objects would appear in the imaging design as compared to potential false positive objects, and the results are summarized in FIG. 8. As can be seen in the first row, image panels (a) and (d) having opposite signs of birefringence show inversion of brightness; for example for α=45°, negative birefringence translates to maximum brightness while positive birefringence translates to minimum brightness; for φ=135°, negative birefringence translates to minimum brightness while positive birefringence translates to maximum brightness. As expected, a non-birefringent and transparent object (see panel image (g)) results in zero signal, whereas a non-birefringent and absorptive object (see panel image (j)) results in reduced brightness.

A close observation of FIG. 8 (panels images a, d, and j) reveals a potential ambiguity of crystal analysis. Although it is safe to declare brighter-than-background objects as birefringent, darker-than-background objects need additional analysis before they can be described as birefringent since an absorptive object could have the same appearance upon single viewing. To resolve this ambiguity, a differential imaging strategy was adopted as described herein. In addition to a single analyzer/sample orientation, the polarization analyzer unit or the sample was rotated by 90°, then the lens-free imaging experiment was repeated; and finally the amplitudes of the two reconstructed images were subtracted, resulting in the differential output \hat{p}ₛ=|\hat{p}_{0°}|−|\hat{p}_{90°}|, where the subscripts 0° and 90° denote the images before and after polarization analyzer unit/sample rotation, respectively. The middle row of images of FIG. 8 depicts the second set of reconstructed images with the polarization analyzer unit rotated by 90°, and the bottom row of images of FIG. 8 shows the subtraction results. As shown in FIG. 8 (panel images c, f and l), the signals due to birefringence are enhanced while the signals due to absorption are exactly canceled out, as desired. This differential image \hat{p}ₛ, in combination with the original lens-free images, \hat{p}_{9°} and \hat{p}_{90°}, help to remove potential false positive objects while also sensitively detecting birefringent objects and determining their sign (i.e., positive or negative). One should note that if a specific birefringent crystal is aligned either at 0° or 90°, the difference lens-free image \hat{p}ₛ, will not show its signature; this is also the case for the standard CPLM and would not constitute a limitation since the individual images at each analyzer position will show the presence of such birefringent crystals (see e.g., FIG. 8, panel images a-f).

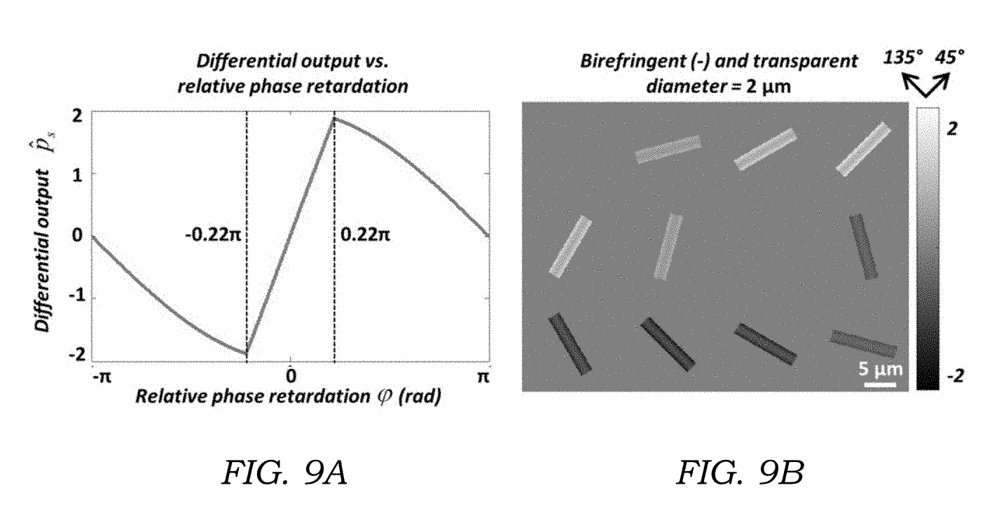

For this differential lens-free imaging design, it is also important to understand and quantify the linearity of the differential output signal \hat{p}ₛ with respect to the relative birefringent phase retardation φ. Here, the crystals are assumed to be aligned at 45° (α=45°). Since \hat{p}ₛ is a periodic function of φ with a period of 2π, one only need to investigate \hat{p}ₛ with respect to φ varying between −π and π, where 0<φ<π implies that the fast axis is along 45°, and −90 <φ<0 implies that the slow axis is along 45°. As shown in 9A, for small φ(|φ|<0.22g), the differential output \hat{p}ₛ is almost perfectly linear as a function of φ. However this linearity does not hold for larger φ. In fact, beyond the turning points |φ|≈0.22π, the curve moves backwards and reaches zero at |φ|=π. This is an interesting observation that is revealed by the numerical simulations and analysis, and it should not affect the sensitivity of the imaging platform. The thickness of the needle-shaped MSU crystal gradually increases from its edge (approximately zero thickness) to the middle (largest thickness), so that the relative phase retardation φ also gradually increases from 0 to its maximum value. Therefore, it is guaranteed that even for a thick MSU crystal with a large maximum φ value, there will be a strong linear birefringence signal toward the edges of the crystal for its detection and identification. This is also verified by the simulation results shown in FIG. 9B, where the diameter of the cylindrical crystal model is increased to 2 μm, and therefore the maximum relative phase retardation is increased to approximately 0.75π. It is shown that, even though at the middle of the crystals the images appear less intense, the strong signal contrast toward the edges is maintained. The same behavior is also verified experimentally.

### Experimental Results on Lens-Free Polarized Imaging of MSU Crystals

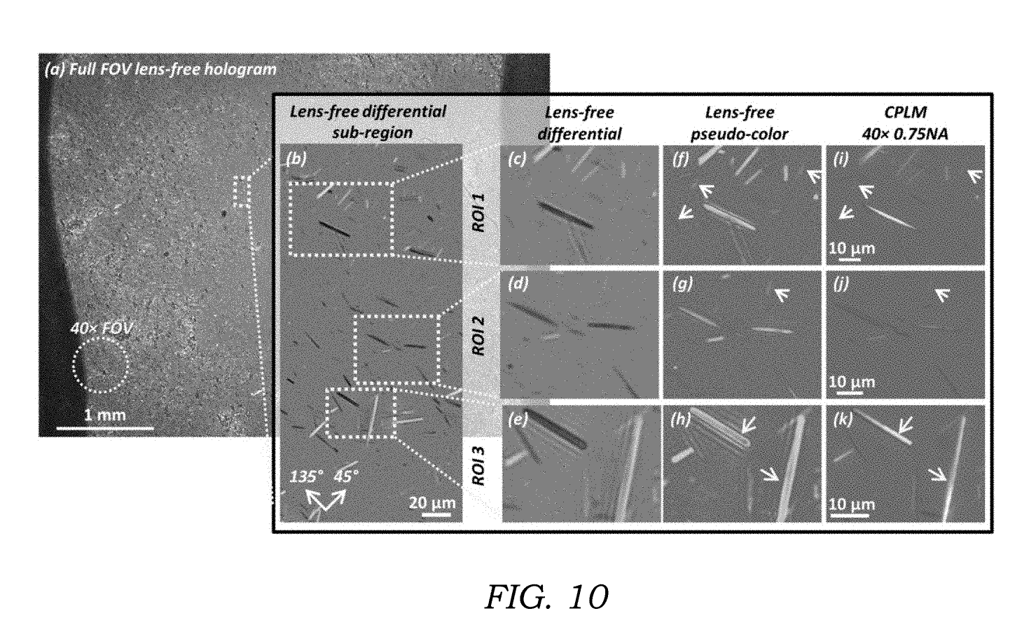

To demonstrate the imaging capabilities of the lens-free polarized on-chip microscopy platform to be used in gout diagnosis, MSU crystal samples were imaged made from the tophus of a de-identified patient using the lens-free microscope. These images were then compared against the gold standard images captured using a benchtop CPLM (Olympus BX51 with additional polarization components: drop-in polarizer U-POT and gout analyzer U-GAN) with a 40×0.75NA objective lens. FIG. 10 (image panel (a)) shows a full-FOV lens-free hologram, captured with the analyzer at 0°. The circular FOV of a typical 40× objective lens (see the dashed circle) is ˜0.24 mm², which is around two orders of magnitude smaller compared to the lens-free FOV. This large FOV of lens-free microscopy offers an important advantage for screening of large areas in the search for scarce crystals, potentially helping to reduce the false-negative rate of diagnosticians. By digitally zooming into a sub-region of the lens-free image (see image panel (b) of FIG. 10), one can see that, as expected, the MSU crystals appear brighter compared to the background when their orientations are close to 45° and darker when their orientations are close to 135°. Three regions of interest (ROI) are further selected from image panel (b) and magnified images are shown in panels (c)-(k). The lens-free pseudo-colored images (FIG. 10, image panels (f)-(h)) are digitally processed from the lens-free grayscale differential reconstruction results (image panels (c)-(e)). Comparing image panels (f) and (g) to the corresponding images of the benchtop CPLM (image panels (i) and (j)), one notices that not only the most prominent objects with strongly yellow or blue colors agree well in each set of images, but even the weak signals are picked up (pointed by the white arrows) by both microscopes; in fact the image contrast of these weak crystals captured by the lens-free microscope is much stronger than the CPLM images. This stronger image contrast suggests the potential enhanced sensitivity of the lens-free polarized microscope.

In panel image (h) of FIG. 10, one also notices that two relatively thicker crystals (pointed by the arrows) result in “hollow” appearances, verifying the predictions of the numerical simulations (see FIG. 9B). Although panel image (h) of FIG. 10 appears somewhat different compared to panel image (k), it should not pose a problem for identification of MSU crystals or gout diagnosis, as these thick MSU crystals are clearly defined by their strong yellow/blue periphery enclosing a hollow interior, with a needle-shaped morphology. For the same thicker crystals, the lens-free images contain some fringes along the crystals that do not exist in the traditional CPLM images. These artifacts result due to diffraction and form a signature of thicker birefringent crystals in lens-free images. However, because of the fact that these fringes will only occur around these thick and strongly birefringent objects and that non-birefringent objects (transparent or absorptive) are canceled out in the differential holographic images, this will not affect the sensitivity of the computational imaging method for crystal arthropathy.

### Experimental Results on Lens-Free Polarized Imaging of Steroid Crystals

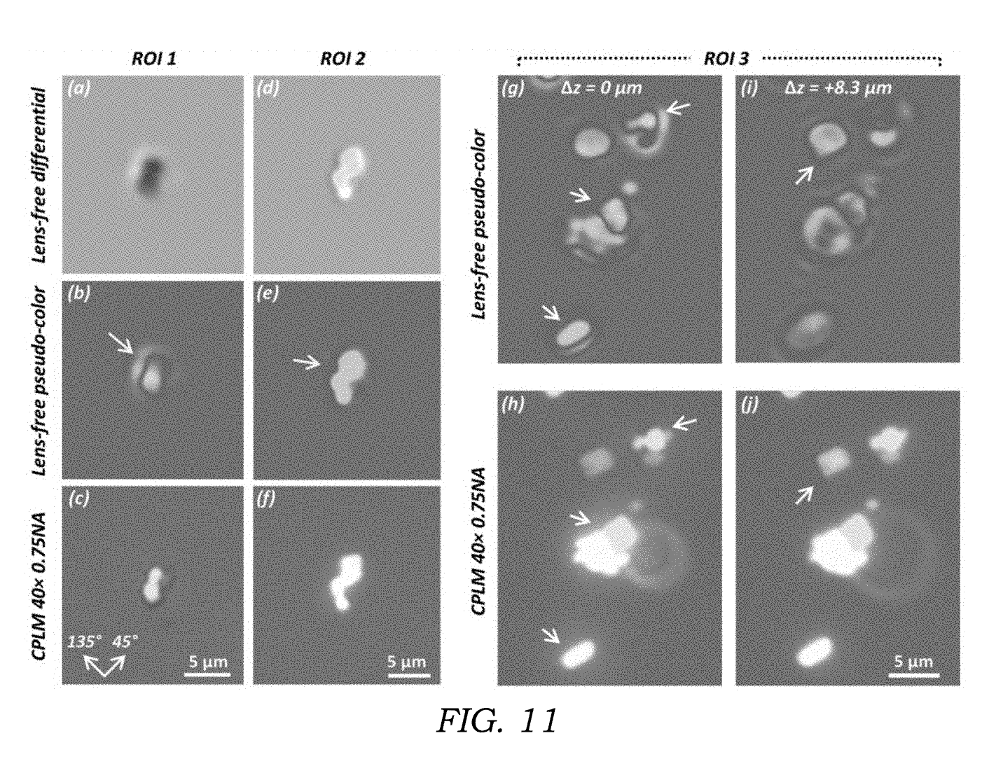

Next, in order to test the performance of the lens-free holographic imaging method to differentiate other types of birefringent crystals from MSU crystals, steroid crystal samples were imaged as a negative control sample. Corticosteroid crystals are birefringent crystals that can be found in some patients' joint fluids following a corticosteroid injection and sometimes can lead to false positives in gout diagnosis. Their irregular shape provides a means to differentiate them from MSU crystals. As shown in FIG. 11, the pseudo-color lens-free polarized microscope images (image panels (b), (e), (g), (i) of these crystals show consistent morphology and birefringence that agree well with the benchtop CPLM images of the same samples (image panels (c), (f), (h), (j). Because of the large thicknesses of these steroid crystals, there exists some glowing artifacts around the crystals' lens-free images (image panels (b), (e), arrows), due to similar reasons previously discussed. In particular, the ROI 3 shown in FIG. 11 (image panels (g)-(j)) contains multiple steroid crystal particles, whose surfaces reside at different depths/heights. Digital re-focusing capability of the lens-free polarized microscope is used to show some of the in-focus images of these respective crystal particles at different z-distances from the sensor chip. In image panels (g) and (i) the lens-free image was digitally refocused to relative Δz distances of 0 μm and 8.3 μm. At these respective planes, the particles on the lens-free images pointed by the arrows are at the best focus, showing distinct and clear shapes that are also consistent with image panels (h) and (j), which had to be manually refocused to the same particles due to the extremely narrow depth of focus of the objective lens used in CPLM. For example, the blue-colored irregularly shaped crystal particle on the top right of ROI 3, pointed by the arrow in image panel (g), is best visualized at Δz=0 μm, and the sharp corner at the bottom of the blue-colored crystal particle, pointed by the white arrow in image panel (i), is best visualized at Δz=8.3 μm. This digital re-focusing capability of the lens-free holographic polarized microscope is an important feature and an advantage for the diagnosis of gout since microscopic samples are usually not perfectly planar—they inevitably have height variations on the order of tens of microns. Moreover, when the user of a conventional microscope translates the sample stage to observe different regions of the sample, the sample can easily get out of focus as the movement of the sample stage is not perfectly horizontal. For a regular sample, since one can constantly refocus the microscope, these issues may be acceptable (at the cost of diagnostician time). But when screening a sample with scarce crystals using a standard benchtop CPLM, there can be scenarios where there are simply not enough birefringent targets to focus on. This would be less of an issue for the lens-free holographic polarized microscope described in this work because of its enhanced depth of field which can span several hundred microns as well as its large FOV that is >20 mm². The lens-free holograms over a large sample area can thus be easily brought into focus by autofocusing and digital back-propagation algorithms as described herein.

### Experimental Results on Lens-Free Polarized Imaging of CPP Crystals

Synovial aspirates from de-identified discarded clinical samples were imaged with the lens-free polarized microscopy device. One different with the experimental setup was that a different angle mismatch was used for the polarization analyzer unit. Specifically, the angle mismatch between the λ/4 retarder and the linear polarizer was +50° which was optimized for the more weakly birefringent CPP crystals. While CPP crystals are visible where the polarizer analyzer angle-mismatch is +65° (i.e., optimized for MSU), by setting the angle-mismatch to +50°, enhancement of the weaker birefringent crystals is improved. However, at +50° MSU crystals lose some of their birefringent intensity.

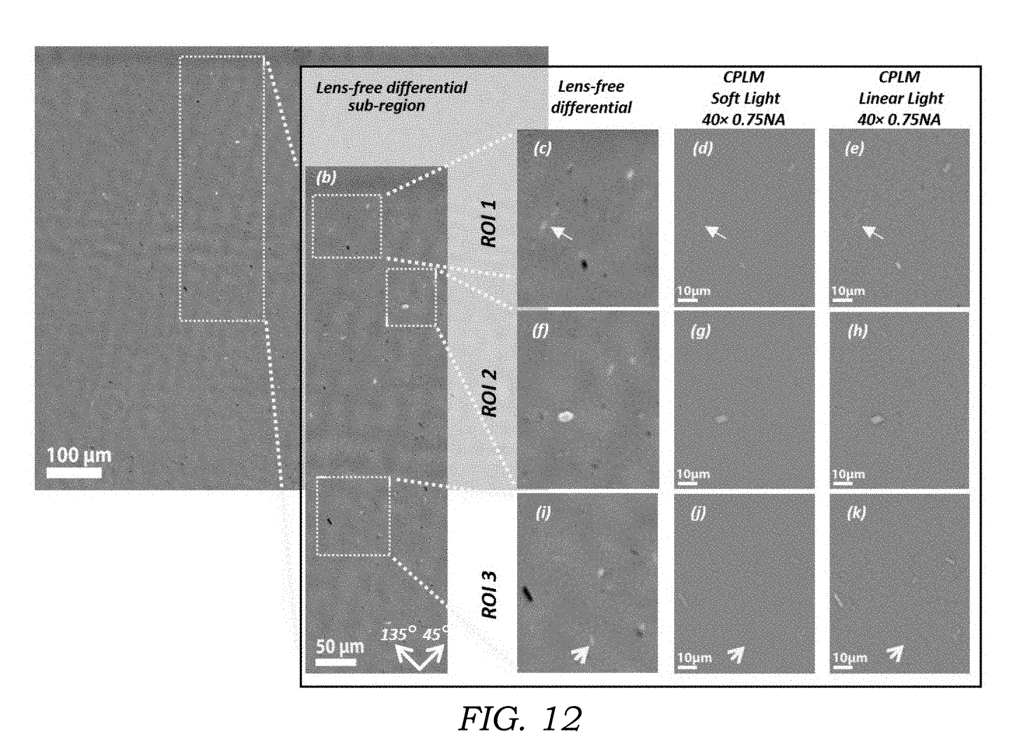

FIG. 12 illustrates a full-FOV lens-free differential hologram image of CPP crystals captured with the microscopy system. Image panel (b) illustrates an enlarged sub-region of the dashed rectangular region from (a). This enlarged sub-region contains three ROIs (ROI 1, ROI 2, ROI 3) that are enlarged again and presented as panel images (c), (f), and (i). Panel image (c) is an enlarged lens-free differential view of ROI 1. Panel image (f) is an enlarged lens-free differential view of ROI 2. Panel image (i) is an enlarged lens-free differential view of ROI 3. Panel images (d), (g), and (j) illustrate CPLM images of the respective ROIs (ROI 1, ROI 2, ROI 3) with a 40×, 0.75 NA microscope using soft light. Panel images (e), (h), and (k) illustrate CPLM images of the respective ROIs (ROI 1, ROI 2, ROI 3) with a 40×, 0.75 NA microscope using linear light. The arrows in panel images (a), (d), and (e) identify the CPP crystal in ROI 1. The CPP crystal is better seen in the lens-free panel image (c) compared to the two CPLM images (d), (e). Similarly, for ROI 3, The CPP crystal (identified by thicker arrows) is better seen in the lens-free panel image (i) compared to the two CPLM images (j), (k).

While embodiments of the present invention have been shown and described, various modifications may be made without departing from the scope of the present invention. The invention, therefore, should not be limited, except to the following claims, and their equivalents.

1. A method of imaging birefringent crystals or materials on an optically transparent sample holder using a lens-free polarized microscopy device comprising:
illuminating a first side of the optically transparent sample holder containing the birefringent crystals or materials with a source of partially coherent or coherent light that is passed through a circular polarizer, wherein the source of partially coherent or coherent light is located a distance (z₁) from the optically transparent sample;
capturing a first plurality of lower resolution holographic images of the birefringent crystals or materials with an image sensor located on a second, opposing side of the optically transparent sample holder, wherein an active imaging surface of the image sensor is located a distance (z₂) from the from the optically transparent sample and z₂<<z₁, wherein a polarization analyzer unit comprising a λ/4 retarder and a linear polarizer is positioned between the optically transparent sample holder and the image sensor in a first orientation;
capturing a second plurality of lower resolution holographic images of the birefringent crystals or materials with the image sensor with the polarization analyzer unit in a second orientation;
reconstructing a phase-retrieved, higher resolution image of the birefringent crystals or materials at the first orientation using the first plurality of lower resolution holographic images of the birefringent crystals;
reconstructing a phase-retrieved, higher resolution image of the birefringent crystals or materials at the second orientation using the second plurality of lower resolution holographic images of the birefringent crystals; and
generating a differential image from the respective phase-retrieved, higher resolution holographic images at the first orientation and the second orientation.

2. The method of claim 1, wherein the second orientation of the polarization analyzer unit is oriented about 90° with respect to the first orientation of the polarization analyzer unit.

3. The method of claim 1, wherein the differential image is formed by image processing software performing amplitude subtraction on the phase-retrieved, higher resolution images at the first orientation and the second orientation.

4. The method of claim 1, wherein the first plurality of lower resolution holographic images and the second plurality of lower resolution images are obtained by relative x, y, and z directional shifts created between the image sensor and the sample holder.

5. The method of claim 1, wherein the polarization analyzer unit is moved from first orientation to the second orientation.

6. The method of claim 1, wherein the optically transparent sample holder is moved from the first orientation to the second orientation.

7. The method of claims 1, wherein the birefringent crystals comprises crystals contained in a biological sample obtained from a subject.

8. (canceled)

9. The method of claim 7, wherein the biological sample comprises synovial fluid.

10. The method of claim 8, wherein the birefringent crystals comprise monosodium urate (MSU) crystals, calcium pyrophosphate (CPP) crystals, or calcium oxalate crystals.

11-12. (canceled)

13. The method of claim 1, wherein the birefringent crystals or materials comprise a mineralogical or geological sample.

14. The method of claim 1, wherein the polarization analyzer unit comprises a laminate structure formed with λ/4 retarder film bonded to linear polarizer film.

15. The method of claim 1, wherein the linear polarizer has an orientation angle (γ) within the range of about 55° to about 75°.

16. The method of claim 1, wherein the linear polarizer has an orientation angle (γ) within the range of about 40 ° to about 60°.

17. The method of claim 1, wherein the birefringent crystals or materials are dried on the optically transparent sample holder.

18. The method of claim 1, wherein the birefringent crystals or materials are contained in a fluid and imaged while suspended in the fluid.

19. A lens-free polarized microscopy device comprising:
a light source emitting coherent or partially coherent light;
a circular polarizer receiving light from the light source;
an optically transparent sample holder configured to hold a sample containing birefringent crystals or materials thereon, the optically transparent sample holder disposed along an optical path and positioned to receive the circular polarized light, wherein the light source is located a distance (z₁) from the optically transparent sample holder;
an image sensor disposed on an opposing side of the optically transparent sample holder and positioned along the optical path, wherein an active imaging surface of the image sensor is located a distance (z₂) from the sample holder and z₂<<z₁;
a mechanical stage configured to move the image sensor in the x, y, and z directions; and
a polarization analyzer unit comprising a λ/4 retarder and a linear polarizer positioned between the sample holder and the image sensor.

20. The lens-free polarized microscopy device of claim 19, further comprising a computer device configured to execute image processing software thereon and receive images generated by the image sensor, wherein the image processing software is configured to reconstruct phase-retrieved, high resolution images of the birefringent crystals of materials in the sample.

21. The lens-free polarized microscopy device of claim 19, wherein one of the polarization analyzer unit or the sample holder is rotatable relative to the image sensor.

22. (canceled)

23. The lens-free polarized microscopy device of claim 19, wherein the wherein the polarization analyzer unit comprises a laminate structure formed by a λ/4 retarder film bonded to a linear polarizer film.
